(19) United States
(12) Patent Application Publication
(10) Pub. No.: US 2020/0102735 A1
(43) Pub. Date: Apr. 2, 2020

(54) Drainage Tape

(71) Applicant: Adam Ugliuzza, Lemoyne, PA (US)

(72) Inventor: Adam Ugliuzza, Lemoyne, PA (US)

(21) Appl. No.: 16/149,894

(22) Filed: Oct. 2, 2018

(51) Int. Cl. E04B 1/70; C09J 7/22; C09J 7/38; E04B 1/62

(52) U.S. Cl. CPC E04B 1/7038; C09J 7/22; B32B 7/12; E04B 1/625; C09J 7/38

(57) ABSTRACT

The drainage tape will be comprised of self-adhered flexible air resistive sheeting and water permeable sheeting. Along the length the tape, there will be sections of self-adhered flexible air resistive sheeting with intermittent drainage channels to all water to weep; the water permeable sheeting runs continuously along the length of the tape and is intended to control airflow at the drainage channels where the air resistive sheeting is omitted. It will be roll-able and have limited compressibility so to maintain the minimum dimension to ensure water drainage can occur.

### BACKGROUND

Interfacing design and installation of building enclosure materials and assemblies are some of the most challenging responsibilities for designers and contactors today and is often misunderstood and/or improperly performed. This often leads to water intrusion, which is the most damaging, and uncontrolled air leakage which results in energy loss, condensation issues and mold, building durability concerns, poor indoor air quality, comfort issues, and more.

Achieving continuity of the air and water barrier when transitioning between building enclosure materials and systems is critical. This cannot be effectively achieved without identifying the plane of air and water tightness, or lack thereof, for the materials and systems included in the design. Consideration must also be must given if unintended failure or construction deficiencies related to the building materials functionality are a potential risk. A common trouble area occurs when barrier materials or systems abut and interface with drainage materials or systems. Barrier materials and systems are designed to stop air and water at the exposed exterior surface. Drainage systems manage bulk air and water at the exterior surface with an internal drainage mechanism that collects and directs moisture out of the system. Often, the internal air and water barrier of the drainage material or system is located inboard of the abutting barrier material or system. If the internal air and water barrier of the drainage material or system is not continuous, it creates a potential path for air and water behind the barrier material or system. Panning and flashing systems are commonly used to provide additional protection when anticipating these conditions.

Current industry standard practice typically incorporates a panning or flashing system to address potential water intrusion, however in many cases the pan or flashing system is not weeped, primarily because typical weeps are exposed to bulk water that tend to also allow water in (vs. weep out) and do not restrict airflow. The goal is that the collected water will eventually evaporate and dry out. This can be problematic as the collection of water can create water head and pressure, prolonging exposure and increasing potential for water to enter at fasteners that often penetrate the panning or flashing system and at panning or flashing end dams, defeating the main purpose for employing the panning or flashing system.

The pressure sensitive self-adhered drainage tape is designed to provide means to efficiently and effectively weep the pan or flashing system while maintaining air and water control. It eliminates exposed weeps and limits water exposure at panning or flashing system penetrations that are prone to water intrusion.

### SUMMARY

Drainage tape provides an easy and economical means to effectively weep panning or flashing systems while mitigating issues that impact building air, water and thermal performance. The design utilizes existing building materials that are readily accessible, which simplifies the manufacturing process and allows for expedited orders.

The main materials that comprise the drainage tape include self-adhered flexible air resistive sheeting and water permeable sheeting, both will have limited compressibility so to allow water to weep. The self-adhered flexible air resistive sheeting will include intermittent drainage channels. The water permeable sheeting will run continuously along the long edges of the air resistive sheeting, spanning the drainage channels. The water permeable sheeting is characteristic of a densely arranged open cell structure or woven material that allows water to weep but restricts airflow. An additional thinner layer of air resistive sheeting is incorporated along the top face of both the intermittent air resistive sheeting and water permeable sheeting to create a bonded assembly. The tape assembly will be provided on a roll.

### BRIEF DESCRIPTION OF DRAWINGS

FIG. 1: View of Tape Assembly with outer membrane removed.

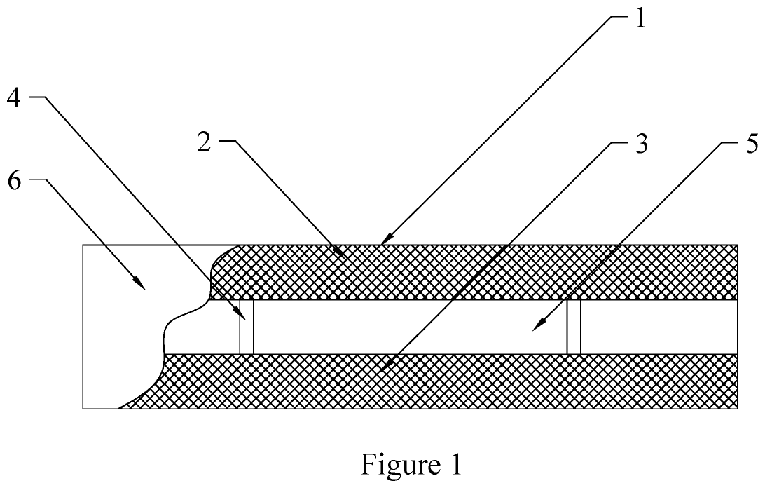

FIG. 2: Cross-section of Second Strip showing Weep Channels.

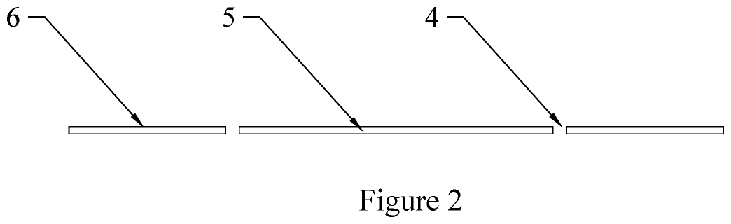

FIG. 3: Edge View of Tape showing Membrane and First/Third Strip

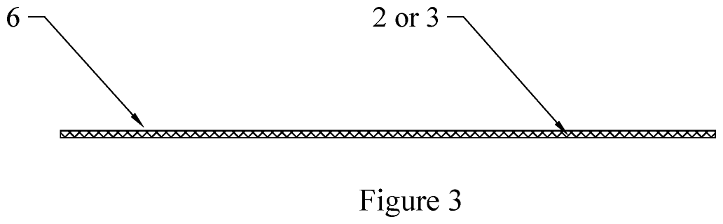

FIG. 4: View of Tape Installed in opening in building structure.

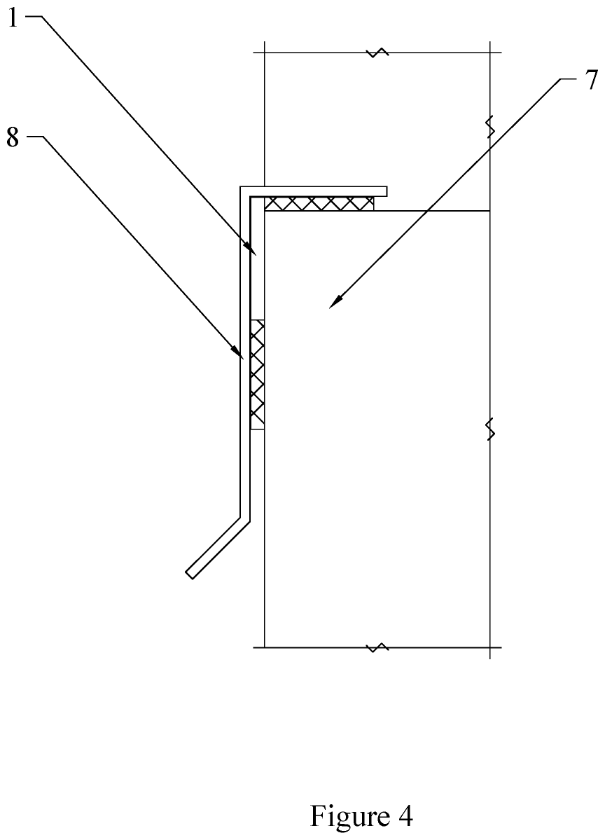

FIG. 5: View of Tape Installed with Window Flange.

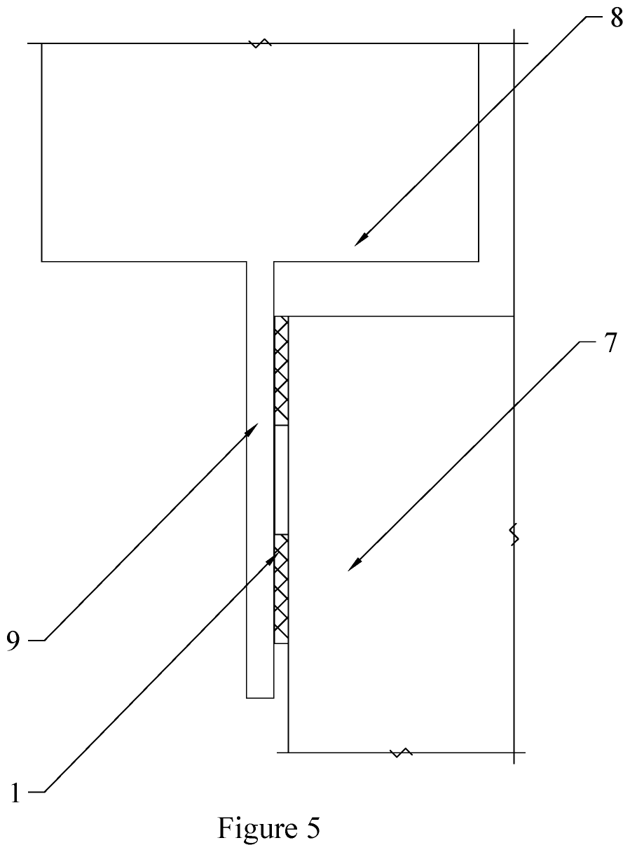

### LABEL LIST

1. Tape

2. First Strip

3. Second Strip

4. Weep Channels

5. Third Strip

6. Membrane

7. Wall Opening

8. Building Component

### DETAILED DESCRIPTION

The present invention comprises of a Tape (1) consisting of multiple strips of various materials adjoining the other strips longitudinally along the length of the Tape (1). The First Strip (2) and Third Strip (3) consists of a water permeable material with limited compressibility that controls the flow of air through the material. In the preferred embodiment the First Strip (2) and Third Strip (3) is similar to a rigid reticulated foam or a woven material, alternatively it can be any material with limited compressibility that controls the flow of air through the cross-section of the Tape (1). The purpose of the First Strip (2) and the Third Strip (3) is to allow water weep and to control the flow of air through the cross-section of the Tape (1) at the Weep Channels (4).

The Second Strip (5) of the Tape is made of an air resistive material with limited compressibility. In the preferred embodiment, this Second Strip (5) is similar to felt. Along the length of the Tape (1), Weep Channels (4) are cut into the Second Strip (5) in regular intervals completely across the width of the Second Strip (5). These Weep Channels (4) create a point of collection and drainage of any water laying or pooling in the pan or flashing area, allowing for the weeping of the pan or flashing area. The Weep Channels (4) do not extend through to the First Strip (2) or Third Strip (3). The Weep Channels (4) allow for the drainage of any water that collects in the pan or flashing. The orientation and geometry of the Weep Channels (3) are designed to minimize airflow paths. The Second Strip (5) must have limited compressibility in order to prevent blockage of the Weep Channels (4) when sandwiched between the two exterior building surfaces. In an alternate embodiment, Weep Channels (4) are provided by forming the Second Strip (5) into a corrugated pattern.

All three strips (2, 3, and 5) are joined on the upper surface with a vapor permeable and water and air resistive Membrane (6). The Membrane (6) has adhesive applied to both sides in order to affix the Strips (2, 3, & 5) to the membrane (6) and to affix the Tape (1) to the building components.

Additionally, a layer of adhesive is affixed to the underside of the Tape (1) across all three strips, this layer of adhesive affixes the underside of the Tape (1) typically at the Wall Opening (7). The adhesive applied to the outside of the Membrane (6) affixes the Tape (1) to the flashing, window flange, cladding or similar building component (8).

A method of joining two exterior building components, whereby the installer adheres the Tape (1) to the building structure at the Wall Opening (7) and oriented such that the first Strip (2) and the inner edge of the Tape (1) extends to Wall Opening (7). The Third Strip (3) extends towards the 100 drainage cavity, to allow for any water passing through the Weep Channels (4) to drain from the 101 Wall Opening (7). The installer then affixes flashing, window flange, cladding or similar building 102 component (8) over the Tape (1). When installing with a window flange (9) the Tape (1) may be 103 installed entirely on the vertical surfaces. Using this installation method the installer can create an 104 air and water barrier at the transition between exterior building components that allows for the 105 Wall Opening (7) to drain out to the exterior building surface.

What is claimed:

1. A Tape Assembly for joining two exterior building components comprising, three parallel strips that creates an air and water barrier while allowing for the drainage of accumulated water from the window opening.

2. The Tape Assembly of claim 1, where the innermost and outermost strips consist of water permeable material with limited compressibility.

3. The Tape Assembly of claim 1, where the middle strip consists of an air resistive non-compressible material.

4. The Tape Assembly of claim 3, where the middle strip has weep channels cut perpendicular to Tape across the width of the middle strip to allow for the flow of water through the Tape.

5. The Tape Assembly of claim 4, where the weep channels are cut into the middle strip at a regular interval.

6. The Tape Assembly of claim 1, where the three parallel strips are joined on their upper surface by an adhesive membrane.

7. The Tape Assembly of claim 6, where the adhesive membrane is vapor permeable and water and air resistive.

8. A method of joining two exterior building components using the Tape Assembly wherein the installer:
a. Attaches the lower surface of the Tape Assembly to the wall opening using the adhesive layer applied to the underside of the Tape Assembly to affix the Tape to the Wall Opening.
b. Attaches the flashing, window flange, cladding or similar building component to the upper side of the Tape Assembly using the adhesive layer applied to the outside of the adhesive membrane.

9. The method of joining two exterior building components using the Tape Assembly in claim 8 where the installer orients the tape from the wall opening to the exterior building component to allow for drainage of water from the wall opening to the exterior of the building.
